(19) United States
(12) Patent Application Publication
(10) Pub. No.: US 2008/0243496 A1
(43) Pub. Date: Oct. 2, 2008

(54) Band Division Noise Suppressor and Band Division Noise Suppressing Method

(75) Inventor: Youhua Wang, Ishikawa (JP)

Correspondence Address: DICKINSON WRIGHT PLLC, 1901 L STREET NW, SUITE 800, WASHINGTON, DC, 20036, US

(73) Assignee: Matsushita Electric Industrial Co., LTD., Osaki (JP)

(21) Appl. No.: 10/592,749

(22) PCT Filed: Jan. 19, 2006
(86) PCT No.: PCT/JP06/00756

§ 371 Date: Sep. 14, 2006

(30) Foreign Application Priority Data
Jan. 21, 2005 (JP) 2005-014772

(51) Int. Cl. G10L 21/02

(52) U.S. Cl. 704/226; 704/227; 704/E21.004

(57) ABSTRACT

A band division noise suppressor suppressing noise sufficiently with a small amount of processing and a little voice distortion. In the band division noise suppressor, a band dividing section (101) divides an input voice signal into a low band voice signal and a high band voice signal. The low band voice signal is subjected to decimate at a decimation section (102), subjected to noise suppression at a low band noise suppressing section (103), and then interpolated at an interpolation section (104). On the other hand, the high band voice signal is subjected to noise suppression at a high band noise suppressing section (105). A band combination section (106) composes the bands of low-band and high-band voice signals subjected to noise suppression and outputs a voice signal subjected to noise suppression over the entire band.

### TECHNICAL FIELD

The present invention relates to a band division noise suppression apparatus and band division noise suppression method that divides background noise into a high band component and low band component and suppresses background noise, and more specifically, to a band division noise suppression apparatus and band division noise suppression method that are suitable for use in mobile terminal apparatus.

### BACKGROUND ART

Generally, a low bit rate speech coding apparatus can provide a high quality communication for speech including few background noise. However, for speech including background noise, abrasive distortion that is unique to low bit rate coding occurs and speech quality deterioration can be caused. Noise suppression/speech emphasis technologies which are performed to deal with the speech quality deterioration are classified into processing technology in time domain and processing technology in frequency domain.

As a noise suppression/speech emphasis technology in time domain, for example, the technology disclosed in Patent Document 1 is known. That is, Patent Document 1 discloses a technology that distinguishes between a speech segment and a non-speech segment by changing a suppression factor determined by short segment power of an input speech signal according to estimated non-speech segment power, and thereby performs appropriate noise suppression.

Furthermore, as a noise suppression/speech emphasis technology in frequency domain, for example, the technology disclosed in Patent Document 2 is known. That is, in Patent Document 2, band division is performed on an input signal, the ratio of speech signal and noise signal for the signal of each band is estimated, and noise is suppressed by multiplying a gain factor for noise suppression calculated based on the ratio and the input signal of each band. Then, Patent Document 2 discloses a technology that masks distortion caused at that time by adding a few pseudo background noise signals which are similar to a noise spectrum, according to the ratio of speech signal and noise signal, and enables effective noise reduction with little distortion. This method distinguishes between band where speech is large (SN ratio is large) and band where noise is large (SN ratio is small), and adds appropriate pseudo background noise, and therefore musical noise is suppressed and speech quality is expected to improve when SN ratio is small.

Furthermore, Patent Document 3 proposes a method for repairing a missing pitch harmonic power spectrum based on two kinds of comb filters generated as extraction and repairing standards of a pitch harmonic power spectrum. This method actively utilizes characteristics of a speech signal (for example, speech pitch harmonic power spectrum), so that it is possible to distinguish between speech band and noise band with high accuracy and, reduce speech distortion and remove noise adequately.
Patent Document 1: Japanese Patent Publication No. 3437264
Patent Document 2: Japanese Patent Publication No. 3309895
Patent Document 3: Japanese Patent Application Laid-Open No. 2002-149200

### DISCLOSURE OF INVENTION

### Problems to be Solved by the Invention

However, there are following problems in these conventional technologies. That is, the noise suppression/speech emphasis technology in time domain disclosed in Patent Document 1 only requires a simple processing method and a small amount of calculation, but cannot perform detailed setting of a suppression factor for each frequency component using frequency characteristics of speech and noise. Therefore, there is a limitation in performance of noise suppression with little speech distortion.

Furthermore, with the noise suppression/speech emphasis technology in frequency domain disclosed in Patent Document 2, part of speech information (SN ratio) is used, but speech signal characteristics (for example, speech pitch harmonic power spectrum) are not actively used. As a result, it is difficult to distinguish between speech band and noise band with high accuracy, and therefore, it is considered difficult to reduce speech distortion and remove noise adequately.

Furthermore, the method for repairing a missing pitch harmonic power spectrum disclosed in Patent Document 3 requires a long discrete Fourier transform length to extract a pitch harmonic power spectrum accurately, and therefore the amount of calculation increases. This becomes a problem for applying to noise suppression apparatus in mobile terminal apparatus.

It is therefore an object of the present invention to provide a band division noise suppression apparatus and band division noise suppression method having little speech distortion and a large amount of noise suppression with a small amount of processing.

### Means for Solving the Problem

The band division noise suppression apparatus according to the present invention adopts a configuration having: a band division section that performs band division on an input speech signal into a low band speech signal including a low frequency noise component and a high band speech signal including a high frequency noise component; a decimation processing section that performs down-sampling on the low band speech signal; a low band noise suppression section that suppresses noise included in the low band speech signal subjected to the decimation processing; an interpolation processing section that performs up-sampling on the noise-suppressed low band speech signal; a high band noise suppression section that suppresses noise included in the high band speech signal; and a band combination section that combines the low band speech signal subjected to the interpolation processing and the high band speech signal subjected to the noise suppression processing.

Furthermore, the band division noise suppression method according to the present invention having: a band division step of performing band division on an input speech signal into a low band speech signal including a low frequency noise component and a high band speech signal including a high frequency noise component; a decimation processing step of performing down-sampling and decimation processing on the low band speech signal; a low band noise suppression step of suppressing noise included in the low band speech signal subjected to the decimation processing; an interpolation processing step of performing up-sampling and interpolation processing on the noise-suppressed low band speech signal; a high band noise suppression step of suppressing noise included in the high band speech signal; and a band combination step of combining the low band speech signal subjected to the interpolation processing and the high band speech signal subjected to the noise suppression processing.

### ADVANTAGEOUS EFFECT OF THE INVENTION

According to the present invention, input speech signal is divided into the low band signal and the high band signal, and decimation processing is performed on the low band signal, so that it is possible to reduce the discrete Fourier transform length used in low band noise suppression processing without decreasing extraction accuracy of a pitch harmonic power spectrum. Furthermore, a simpler noise suppression processing technique than low band noise suppression processing, is applied to the high band signal. Therefore, it is possible to provide a band division noise suppression apparatus and band division noise suppression method having little distortion and a large amount of noise suppression with a small amount of processing.

### BRIEF DESCRIPTION OF DRAWINGS

FIG. 1 is a block diagram showing a configuration of a band division noise suppression apparatus according to an embodiment of the present invention;

FIG. 2 is a block diagram showing a configuration example of the low band noise suppression section shown in FIG. 1;

FIG. 3 is a block diagram showing a configuration example of the high band noise suppression section shown in FIG. 1; and

FIG. 4 is a spectrogram illustrating the operation in a material element of the low band noise suppression section shown in FIG. 2.

### BEST MODE FOR CARRYING OUT THE INVENTION

Embodiments of the present invention will be described in detail below with reference to the accompanying drawings.

### Embodiment 1

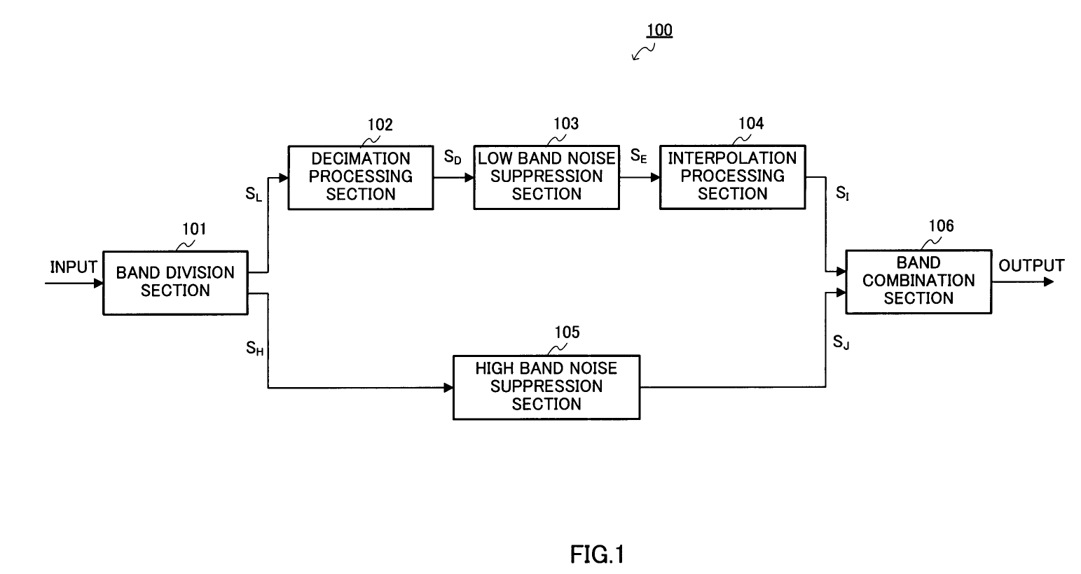

FIG. 1 is a block diagram showing a configuration of the band division noise suppression apparatus according to an embodiment of the present invention. In FIG. 1, band division noise suppression apparatus 100 according to this embodiment has: band division section 101; decimation processing section 102; low band noise suppression section 103; interpolation processing section 104; high band noise suppression section 105; and band combination section 106.

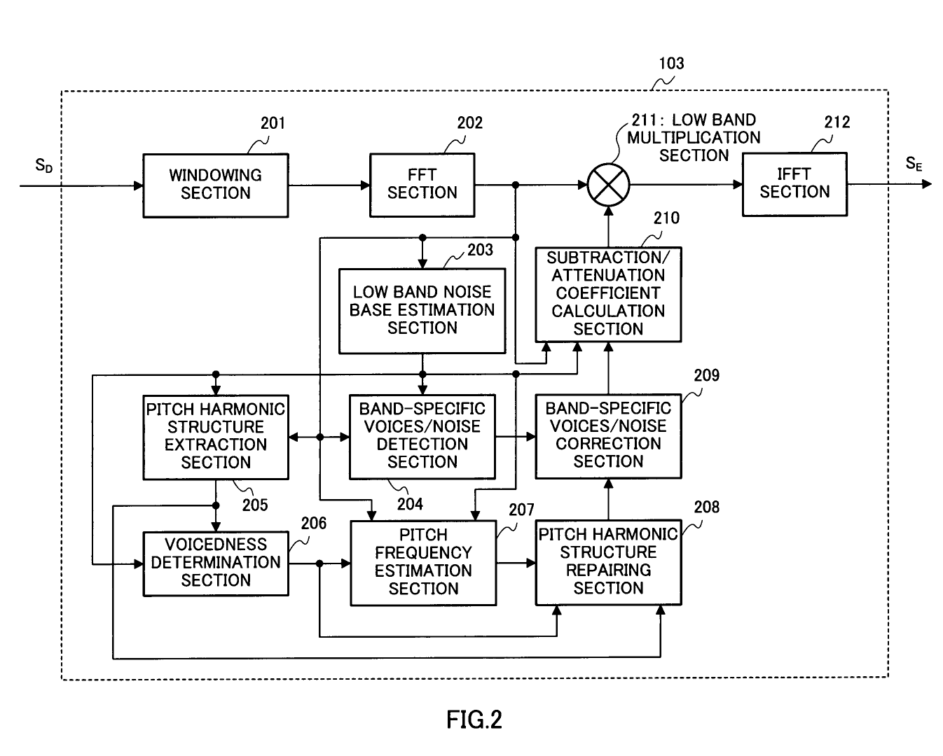

Furthermore, FIG. 2 is a block diagram showing a configuration example of low band noise suppression section 103 shown in FIG. 1. Low band noise suppression section 103 shown in FIG. 2 has: windowing section 201; FFT section 202; low band noise base estimation section 203; band-specific voiced/noise detection section 204; pitch harmonic structure extraction section 205; voicedness determination section 206; pitch frequency estimation section 207; pitch harmonic structure repairing section 208; band-specific voiced/noise correction section 209; subtraction/attenuation coefficient calculation section 210; low band multiplication section 211; and IFFT section 212.

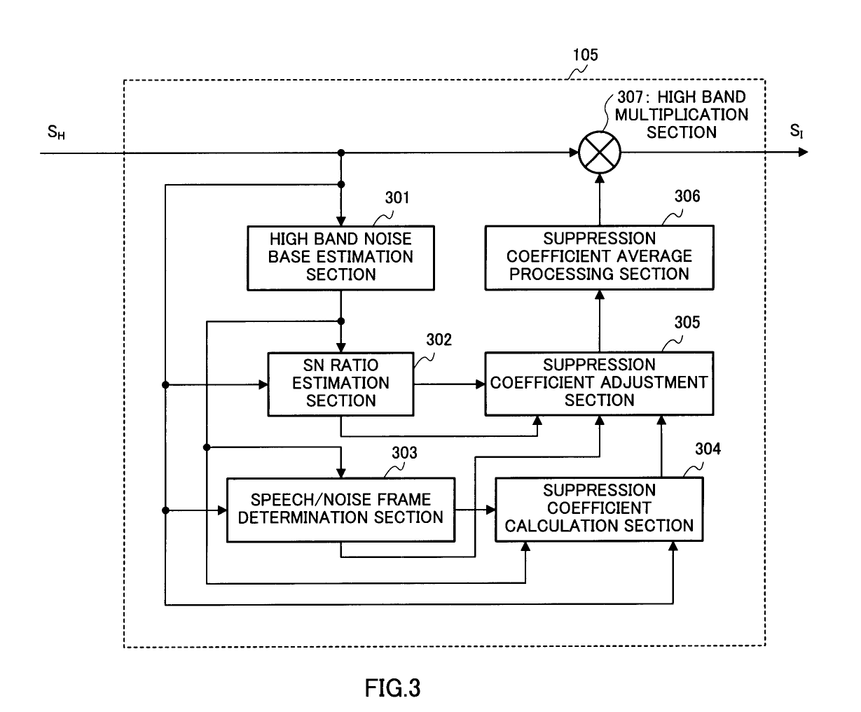

Furthermore, FIG. 3 is a block diagram showing a configuration example of high band noise suppression section 105 shown in FIG. 1. High band noise suppression section 105 shown in FIG. 3 has: high band noise base estimation section 301; SN ratio estimation section 302; speech/noise frame determination section 303; suppression coefficient calculation section 304; suppression coefficient adjustment section 305; suppression coefficient averaging processing section 306; and high band multiplication section 307.

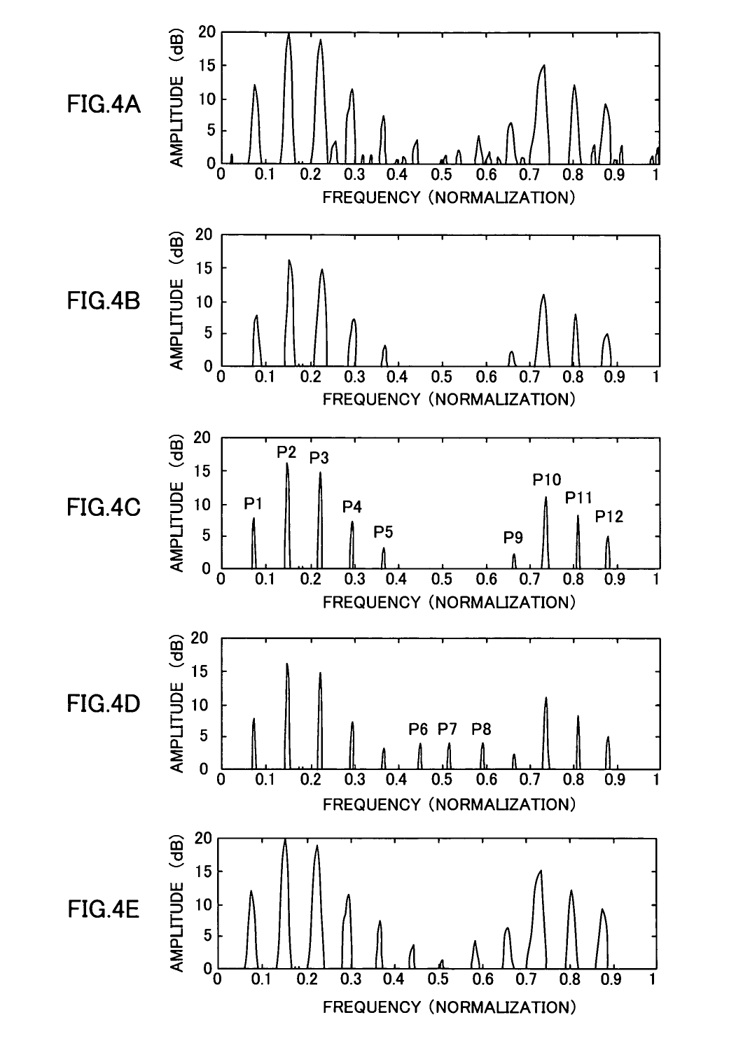

Next, noise suppression operation performed in band division noise suppression apparatus 100 configured as described above will be explained with reference to FIGS. 1 to 4. In addition, FIG. 4 is a spectrogram illustrating the operation in a material element of low band noise suppression section 103 shown in FIG. 2.

In FIG. 1, band division section 101 divides an input speech signal including noise into a speech signal including a low frequency noise component (hereinafter referred to as “a low band speech signal”) S_{L} and a speech signal including a high frequency noise component (hereinafter referred to as “a high band speech signal”) S_{H} using an FIR (Finite Impulse Response) type or IIR (Infinite Impulse Response) type lowpass filter and highpass filter.

The divided low speech signal S_{L} is subjected to noise suppression processing via a route of decimation processing section 102, low band noise suppression section 103 and interpolation processing section 104, and inputted to band combination section 106. On the other hand, the divided high speech signal S_{H} is subjected to noise suppression processing at high band noise suppression section 105, and inputted to band combination section 106. Band combination section 106 performs band combination processing on the noise-suppressed low band and high band speech signals, and outputs a full band speech signal in which a noise component is suppressed to a low level, as an output of band division noise suppression apparatus 100.

First, noise suppression processing of low band speech signal S_{L} performed through decimation processing section 102, low band noise suppression section 103 and interpolation processing section 104 will be described.

Decimation processing section 102 performs down-sampling on low band speech signal S_{L} to be inputted, generates decimated low band speech signal S_{D} and provides the result to low band noise suppression section 103. At decimation processing section 102, for example, using equation (1) below, half down-sampling is performed on low band speech signal S_{L}(i), and generates a decimated low band speech signal S_{D}(i).

### [Equation 1]

S_{D}(i)=S_{L}(2·i) (1)

Low band noise suppression section 103 performs noise suppression processing on the decimated low band speech signal S_{D} and provides the processing result to interpolation processing section 104. There are various low band noise suppression processing methods, but here, a noise suppression processing method shown in Patent Document 3 will be described as one example. FIG. 2 is configured so that the noise suppression method shown in Patent Document 3 is performed. The noise suppression method will be described with reference to FIG. 2 and FIG. 4.

In FIG. 2, windowing section 201 separates low band speech signal S_{D} inputted from decimation processing section 102 into predetermined time units (frames), performs windowing processing using the Hanning window or the like, and outputs the result to FFT section 202.

FFT section 202 performs FFT (Fast Fourier Transform) processing on the speech signal of frame units inputted from windowing section 201 and transforms the speech signal on the time axis into the signal on the frequency axis (speech power spectrum). In this way, the speech signal of frame units becomes a speech power spectrum having a predetermined frequency band. The generated speech power spectrum is inputted to low band noise base estimation section 203, band-specific voiced/noise detection section 204, pitch harmonic structure extraction section 205, voicedness determination section 206, subtraction/attenuation coefficient calculation section 210 and low band multiplication section 211.

Speech power spectrum S_{F}(k) in frequency component k acquired at FFT section 202 is expressed in next equation (2) below.

### [Equation 2]

S_{F}(k)={square root over (Re{D_{F}(k)}²+Im{D_{F}(k)}²)}1≦k≦HB/2 (2)

In equation (2), k is a number which specifies a frequency component. HB is an FFT transform length, that is, the number of data on which fast Fourier transform is performed. For example, HB=256. Furthermore, Re {D_{F}(k)} and Im{D_{F}(k)} indicate respectively the real part and the imaginary part of FFT transformed speech power spectrum D_{F}(k).

First, low band noise base estimation section 203 applies inputted speech power spectrum S_{F}(k) to equation (3) below and estimates a frequency amplitude spectrum of a signal including only the noise component, that is, noise base N_{B}(n,k).

$$\begin{matrix}[ Equation 3 ] & \\ {N}_{B} ( n , k ) = \{ \begin{matrix}{N}_{B} ( n - 1 , k ) & {S}_{F} ( k ) > {Θ}_{B} \cdot {N}_{B} ( n - 1 , k ) \\ ( 1 - α ) \cdot {N}_{B} ( n - 1 , k ) + α \cdot {S}_{F} ( k ) & {S}_{F} ( k ) \leq {Θ}_{B} \cdot {N}_{B} ( n - 1 , k )\end{matrix} \\ 1 \leq k \leq HB / 2 & ( 3 )\end{matrix}$$

In equation (3), n is a frame number. N_{B}(n−1,k) is an estimated value of noise base in an anterior frame. α is a noise base moving average coefficient. Furthermore, Θ_{B} is a threshold value for distinguishing between speech component and noise component.

Then, low band noise base estimation section 203 compares a speech power spectrum generated from the latest frame from FFT section 202 and noise base that estimates a speech power spectrum generated from a frame before the latest frame in each frequency component in frequency band of the speech power spectrum. As a result of comparison, if the power difference between two exceeds the threshold value set in advance, the latest frame is determined to include speech component, and noise base estimation is not performed. On the other hand, if the difference does not exceed the above threshold value, the latest frame is determined not to include speech component, and noise base is updated.

In this way, the estimated noise base is inputted to band-specific voiced/noise detection section 204, pitch harmonic structure extraction section 205, voicedness determination section 206, pitch frequency estimation section 207 and subtraction/attenuation coefficient calculation section 210.

Next, band-specific voiced/noise detection section 204 applies speech power spectrum S_{F}(k) from FFT section 202 and noise base estimate value N_{B}(n,k) from low band noise base estimation section 203 to equation (4) below and detects voiced band and noise band in speech power spectrum S_{F}(k). Detection result S_{N}(k) is inputted to band-specific voiced/noise correction section 209.

$$\begin{matrix}[ Equation 4 ] & \\ {S}_{N} ( k ) = \{ \begin{matrix}{S}_{F} ( k ) - {γ}_{1} \cdot {N}_{B} ( n , k ) & {S}_{F} ( k ) > {γ}_{1} \cdot {N}_{B} ( n , k ) \\ 0 & {S}_{F} ( k ) \leq {γ}_{1} \cdot {N}_{B} ( n , k )\end{matrix} \\ 1 \leq k \leq HB / 2 & ( 4 )\end{matrix}$$

As shown in equation (4), difference between speech power spectrum S_{F}(k) and noise base estimate value N_{B}(n,k) multiplied by constant γ₁ is calculated, and if the result is equal to or greater than zero, the band is determined to be voiced band including speech, otherwise, the band is determined to be noise band not including speech. FIG. 4 (A) is one example of detection result S_{N}(k) of voiced band and noise band determined and detected using equation (4).

Next, pitch harmonic structure extraction section 205 applies speech power spectrum S_{F}(k) inputted from FFT section 202 and noise base estimate value N_{B}(n,k) inputted from low band noise base estimation section 203 to equation (5) below and extracts pitch harmonic power spectrum H_{M}(k) and outputs extraction result H_{M}(k) to voicedness determination section 206 and pitch harmonic structure repairing section 208.

$$\begin{matrix}[ Equation 5 ] & \\ {H}_{M} ( k ) = \{ \begin{matrix}{S}_{F} ( k ) - {γ}_{2} \cdot {N}_{B} ( n , k ) & {S}_{F} ( k ) > {γ}_{2} \cdot {N}_{B} ( n , k ) \\ 0 & {S}_{F} ( k ) \leq {γ}_{2} \cdot {N}_{B} ( n , k )\end{matrix} \\ 1 \leq k \leq HB / 2 & ( 5 )\end{matrix}$$

As shown in equation (5), difference between speech power spectrum S_{F}(k) and noise base estimate value N_{B}(n,k) multiplied by constant γ₂ (γ₂>γ₁) is calculated and if the result is equal to or greater than zero, the band is determined to include pitch harmonic power spectrum H_{M}(k), otherwise, the band is determined not to include pitch harmonic power spectrum H_{M}(k). FIG. 4 (B) is one example of the extraction result of pitch harmonic power spectrum H_{M}(k) extracted using equation (5).

Next, voicedness determination section 206 determines voicedness of speech power spectrum S_{F}(k) based on noise base estimate value N_{B}(n,k) inputted from low band noise base estimation section 203 and the extraction result of a pitch harmonic power spectrum inputted from pitch harmonic structure extraction section 205, and outputs the determination result to pitch frequency estimation section 207 and pitch harmonic structure repairing section 208.

Specifically, voicedness determination section 206, for example, calculates a ratio between the sum of pitch harmonic power spectrum H_{M}(k) and the sum of noise base estimate value N_{B}(n,k) at predetermined frequency band using equation (6) and determines the degree of voicedness based on the result. At pitch frequency estimation section 207 and pitch harmonic structure repairing section 208 which receive the determination result, when the degree of voicedness is determined to be high, pitch frequency estimation and pitch harmonic structure repairing are performed, and when the degree of viocedness is determined to be low, pitch frequency estimation and pitch harmonic structure repairing are not performed. In equation (6), HP is a higher limit frequency component in predetermined frequency band.

$$\begin{matrix}[ Equation 6 ] & \\ {V}_{S} = {\sum }_{k = 1}^{HP} {H}_{M} ( k ) / {\sum }_{k}^{HP} {N}_{B} ( n , k ) & ( 6 )\end{matrix}$$

Next, pitch frequency estimation section 207 estimates pitch frequency based on speech power spectrum S_{F}(k) inputted from FFT section 202, noise base estimate value N_{B}(n,k) inputted from low band noise base estimation section 203 and the voicedness determination result inputted from voicedness determination section 206. At this time, as a result of determination by voicedness determination section 206, if the voicedness of the speech power spectrum is equal to or lower than the predetermined level, pitch frequency estimation is avoided. The estimation result is inputted to pitch harmonic structure repairing section 208. There are various methods in pitch frequency estimation, but, for example, autocorrelation method by autocorrelation function of a speech waveform and deformation correlation method by autocorrelation function of a residual signal of LPC analysis, can be used.

Next, pitch harmonic structure repairing section 208 repairs a pitch harmonic power spectrum based on the extraction result of the pitch harmonic power spectrum inputted from pitch harmonic structure extraction section 205, the voicedness determination result inputted from voicedness determination section 206 and the pitch frequency estimate value inputted from pitch frequency estimation section 207. At this time, as a result of determination by voicedness determination section 206, if the voicedness of the speech power spectrum is equal to or lower than the predetermined level, repairing of the pitch harmonic power spectrum is avoided. The repaired pitch harmonic power spectrum is inputted to band-specific voiced/noise correction section 209.

At voicedness determination section 206, if the voicedness of the speech power spectrum is determined to be high, pitch harmonic structure repairing section 208 repairs a pitch harmonic power spectrum using, for example, the following procedure.

That is, pitch harmonic structure repairing section 208, first, extracts a pitch harmonic peak at pitch harmonic power spectrum H_{M}(k). For example, as shown in FIG. 4(C), peaks P1 to P5 and P9 to P12 are extracted.

Next, pitch harmonic structure repairing section 208 calculates intervals between the extracted peaks. When the calculated interval exceeds a predetermined threshold value (for example, 1.5 times the pitch frequency), missing peaks (peaks P6, P7 and P8 shown in FIG. 4 (D)) in pitch harmonic power spectrum H_{M}(k) are inserted based on the estimated pitch frequency m. In this way, pitch harmonic power spectrum H_{M} (k) is repaired.

Next, band-specific voiced/noise correction section 209 combines the repairing result inputted from pitch harmonic structure repairing section 208 and the detection result inputted from band-specific voiced/noise detection section 204, corrects the band-specific voiced/noise detection result, and outputs the correction result to subtraction/attenuation coefficient calculation section 210.

Specifically, band-specific voiced/noise correction section 209 compares the pitch harmonic structure repairing result shown in FIG. 4(D) and the band-specific voiced/noise detection result S_{N}(k) shown in FIG. 4 (A). Then band overlapped with the pitch harmonic structure repairing result is regarded as voiced band, and the rest of the band is regarded as noise band. Band-specific voiced/noise correction section 209 corrects band-specific voiced/noise detection result S_{N}(k) at band-specific voiced/noise detection section 204. FIG. 4(E) is one example of a result of correcting the band-specific voiced/noise detection result shown in FIG. 4(A).

As shown in FIG. 4 (E), band-specific voiced/noise correction section 209 regards a part overlapped with the repaired pitch harmonic power spectrum H_{M}(k) as voiced band, and a part not overlapped with the repaired pitch harmonic power spectrum H_{M}(k) as noise band. In this way, detection result S_{N}(k) is corrected.

Next, subtraction/attenuation coefficient calculation section 210 calculates a subtraction/attenuation coefficient based on speech power spectrum S_{F}(k) inputted from FFT section 202, noise base estimate value N_{B}(n,k) inputted from low band noise base estimation section 203 and the correction result inputted from band-specific voiced/noise correction section 209, and outputs the result to multiplication section 211.

Specifically, subtraction/attenuation coefficient calculation section 210 calculates subtraction/attenuation coefficient G_{C}(k) for both voiced band and noise band in the corrected detection result S_{N}(k) based on speech power spectrum S_{F}(k) and noise base N_{B}(n,k) using equation (7) below. In equation (7), μ is a constant. Furthermore, g_{c} is a predetermined constant which is greater than zero and smaller than 1.

$$\begin{matrix}[ Equation 7 ] & \\ {G}_{C} ( k ) = \{ \begin{matrix}\vert {S}_{F} ( k ) - μ \cdot {N}_{B} ( n , k ) \vert / {S}_{F} ( k ) & speechband \\ {g}_{C} & noiseband\end{matrix} \\ 1 \leq k \leq HB / 2 & ( 7 )\end{matrix}$$

Next, low band multiplication section 211 multiplies voiced band and noise band of the speech power spectrum inputted from FFT section 202 by the subtraction/attenuation coefficient inputted from subtraction/attenuation coefficient calculation section 210. By this means, a speech power spectrum in which the noise component in the low band speech signal is suppressed, is obtained. This multiplication result is inputted to IFFT section 212.

IFFT section 212 performs IFFT (Inverse Fast Fourier Transform) processing on the noise-suppressed speech power spectrum inputted from low band multiplication section 211. By this means, low band speech signal S_{E} on time axis is generated from the speech power spectrum in which the noise component is suppressed. Generated low band speech signal S_{E} is inputted to interpolation processing section 104.

Interpolation processing section 104 performs interpolation processing by, for example, double up-sampling on noise-suppressed low band speech signal S_{E}(i), generates noise-suppressed low band speech signal S_{I}(i), and provides the result to one input end of band combination section 106.

$$\begin{matrix}[ Equation 8 ] & \\ {S}_{I} ( i ) = \{ \begin{matrix}{S}_{E} ( i / 2 ) & i = 0 , \pm 2 , \pm 4 , \pm 6 , … \\ 0 & others\end{matrix} & ( 8 )\end{matrix}$$

Next, the operation of high band noise suppression section 105 performing noise suppression processing on divided high band speech signal S_{H} will be described with reference to FIG. 3. In FIG. 3, divided high band speech signal S_{H} is inputted to high band noise base estimation section 301, SN ratio estimation section 302, speech/noise frame determination section 303, suppression coefficient calculation section 304 and high band multiplication section 307.

High band noise base estimation section 301 estimates noise signal power included in inputted high band speech signal S_{H} using equations (9) and (10) below, and outputs the estimation result together with high band speech signal S_{H} to SN ratio estimation section 302, speech/noise frame determination section 303, and suppression coefficient calculation section 304.

That is, high band noise base estimation section 301 first calculates addition value S(n) of high band speech signal power using equation (9) below.

$$\begin{matrix}[ Equation 9 ] & \\ S ( n ) = {\sum }_{i = 1}^{{F}_{L}} {S}_{H} ( i ) & ( 9 )\end{matrix}$$

In equation (9), n is a frame number, and F_{L} is a frame length.

Then, high band noise base estimation section 301 estimates high band noise base N(n) using equation (10) below.

$$\begin{matrix}[ Equation 10 ] & \\ N ( n ) = \{ \begin{matrix}N ( n - 1 ) & S ( n ) > Θ \cdot N ( n - 1 ) \\ ( 1 - β ) \cdot N ( n - 1 ) + β \cdot S ( n ) & S ( n ) \leq Θ \cdot N ( n - 1 )\end{matrix} & ( 10 )\end{matrix}$$

In equation (10), β is a moving average coefficient and Θ is a threshold value for distinguishing between speech and noise.

Next, SN ratio estimation section 302 applies high band speech signal S_{H} and high band noise base estimate value N(n) to equation (11) below, estimates ratio SN(n) between speech signal power and noise signal power at high band, and outputs the estimated ratio SN(n) to suppression coefficient adjustment section 305.

### [Equation 11]

SN(n)=(1−ρ)·SN(n−1)+ρ·S(n)/N(n) (11)

In equation (11), ρ is a moving average coefficient.

Next, speech/noise frame determination section 303 applies high band speech signal S_{H} and high band noise base estimate value N(n) to equation (12) below, determines speech/noise frame SNF (n), and outputs that determined speech/noise frame SNF(n) to suppression coefficient adjustment section 305.

$$\begin{matrix}[ Equation 12 ] & \\ SNF ( n ) = \{ \begin{matrix}1 speechframe ) & When S ( n ) > Θ \cdot N ( n - 1 ) \\ 0 ( noiseframe ) & When S ( n ) \leq Θ \cdot N ( n - 1 ) is continued for M frames\end{matrix} & ( 12 )\end{matrix}$$

In equation (12), M is the number of hangover frames. As shown in equation (12), when S(n)>Θ·N(n−1), it is unconditionally determined that SNF(n)=1(speech frame). On the other hand, when S(n)≦Θ·N(n−1), and that S(n)≦ΘN(n−1) is continued for M frames, it is determined that SNF(n)=0(noise frame), and when S(n)≦Θ·N(n−1) is not continued for M frames, it is determined that SNF(n)=1(speech frame).

Next, suppression coefficient calculation section 304 applies high band speech signal S_{H} and high band noise base estimate value N(n) to equation (13), calculates suppression coefficient G_{H}(n) per frame, and outputs the calculated suppression coefficient G_{H}(n) per frame to suppression coefficient adjustment section 305.

$$\begin{matrix}[ Equation 13 ] & \\ {G}_{H} ( n ) = \frac{λ \cdot S ( n )}{S ( n ) + κ \cdot N ( n )} & ( 13 )\end{matrix}$$

In equation (13), parameter λ is λ≦1, parameter κ is κ≧1, and both are adjustable.

Next, suppression coefficient adjustment section 305 adjusts parameters λ and κ of suppression coefficient G_{H} (n) based on the results inputted from SN ratio estimation section 302, speech/noise frame determination section 303, and suppression coefficient calculation section 304, and outputs the adjustment results to suppression coefficient averaging processing section 306.

Next, suppression coefficient adjustment section 305, specifically, performs adjustment of parameter κ shown in equation (13) based on the estimate value of the SN ratio. For example, when the SN ratio is large, the value of κ is made greater, and when the SN ratio is small, a value of κ is made smaller. Furthermore, adjustment of parameter λ shown in equation (13) is performed based on the determination result of speech/noise frame. For example, a value of λ is assumed to be 1 in a speech frame, and a value of λ is assumed to be smaller than 1 in a noise frame.

Next, suppression coefficient averaging processing section 306 performs averaging processing of the suppression coefficient inputted from suppression adjustment section 305 using equation (14) below, and outputs the obtained average value of the suppression coefficient to high band multiplication section 307.

$$\begin{matrix}[ Equation 14 ] & \\ \overline{{G}_{H}} ( n ) = \{ \begin{matrix}( 1 - {η}_{F} ) \cdot \overline{{G}_{H}} ( n - 1 ) + {η}_{F} \cdot {G}_{H} ( n ) & {G}_{H} ( n ) > \overline{{G}_{H}} ( n ) \\ ( 1 - {η}_{S} ) \cdot \overline{{G}_{H}} ( n - 1 ) + {η}_{S} \cdot {G}_{H} ( n ) & {G}_{H} ( n ) \leq \overline{{G}_{H}} ( n )\end{matrix} & ( 14 )\end{matrix}$$

In equation (14), η_{F} and ηₛ are transfer average coefficients, and there is a relationship of 0<ηₛ≦η_{F}<1.

Then, high band multiplication section 307 multiplies high band speech signal S_{H} and the average value of the suppression coefficient, generates noise-suppressed high band speech signal S_{J}, and provides it to another input end of band combination section 106.

Thus, band combination section 106 combines speech signal S_{I} subjected to low-band noise suppression and speech signal S_{J} subjected to high-band noise suppression, and obtains an output of band division noise suppression apparatus 100. For example, first, to remove an imaging component, band combination section 106 performs filtering on speech signal S_{I} subjected to low-band noise suppression and speech signal S_{J} subjected to high-band noise suppression using the same lowpass filter and highpass filter as those used in band division. Next, the filtering results are added per frame and outputted as an output from band division noise suppression apparatus 100.

In this way, according to this embodiment, the input speech signal is divided into speech signal including low frequency component and speech signal including high frequency component, and decimation processing is performed on the signal of low frequency where the power of the input speech signal is large, so that it is possible to perform more accurate noise suppression processing with a small amount of calculation. Furthermore, a simpler noise suppression processing method than low band noise suppression processing is applied to the signal of high frequency where the power of the input speech signal is small, so that it is possible to reduce speech distortion and remove noise adequately with a smaller amount of calculation.

At this time, in suppression processing of low band noise, first, voiced band and noise band are detected and a speech pitch harmonic power spectrum buried in noise and missing is repaired based on the estimated pitch frequency. Next, the determination result of voiced band and noise band is corrected by combining the pitch harmonic power spectrum and the detection results of voiced band and noise band, so that it is possible to determine voiced band and noise band more accurately. As a result, subtraction processing with the small degree of attenuation and attenuation processing with the large degree of attenuation can be respectively performed on voiced band and noise band, so that it is possible to perform noise suppression with little speech distortion even if the amount of attenuation is made large.

Furthermore, in high band noise suppression processing, a noise suppression coefficient and an average value thereof of signal components of high band frequency are calculated, noise suppression processing is performed in time domain, so that it is possible to substantially reduce the amount of calculation and the amount of memory.

Furthermore, in high band noise suppression processing, suppression coefficient calculation is performed based on an addition value of speech signal power of a high frequency and an estimate value of high band noise base, so that it is possible to calculate the suppression coefficient with a small amount of processing.

Furthermore, in high band noise suppression processing, high band noise suppression is performed using the estimation result of the high band SN ratio, so that it is possible to adjust the amount of high band noise suppression according to changes in the SN ratio, and thereby improve noise suppression performance between low band and high band. Furthermore, high band noise suppression is performed using the high band speech/noise frame determination result, so that it is possible to further reduce noise in the noise frame, and thereby substantially suppress high band noise which can be easily heard.

Still further, in high band noise suppression processing, averaging processing of suppression coefficients is performed, so that it is possible to improve continuity between frames and obtain noise suppression performance with high speech quality.

The present application is based on Japanese Patent Application No. 2005-014772, filed on Jan. 21, 2005, the entire content of which is expressly incorporated by reference herein.

### INDUSTRIAL APPLICABILITY

The present invention is useful as a noise suppression apparatus that can reduce speech distortion and remove noise adequately with a small amount of calculation, and in particular, is suitable for use in mobile telephones.

1. A band division noise suppression apparatus comprising:
a band division section that performs band division on an input speech signal into a low band speech signal including a low frequency noise component and a high band speech signal including a high frequency noise component;
a decimation processing section that performs down-sampling and decimation processing on the low band speech signal;
a low band noise suppression section that suppresses noise included in the low band speech signal subjected to the decimation processing;
an interpolation processing section that performs up-sampling and interpolation processing on the noise-suppressed low band speech signal;
a high band noise suppression section that suppresses noise included in the high band speech signal; and
a band combination section that combines the low band speech signal subjected to the interpolation processing and the high band speech signal subjected to the noise suppression processing.

2. The band division noise suppression apparatus according to claim 1, wherein the low band noise suppression section comprises:
a low band noise base estimation section that estimates noise base comprising a noise component spectrum from a low band speech power spectrum;
a voiced/noise detection section that detects a voiced band and a noise band from the speech power spectrum using the speech power spectrum and the noise base;
a pitch harmonic structure extraction section that extracts a pitch harmonic power spectrum from the speech power spectrum using the speech power spectrum and the noise base;
a pitch frequency estimation section that estimates a pitch frequency in the speech power spectrum using the speech power spectrum and the noise base;
a pitch harmonic structure repairing section that repairs the extracted pitch harmonic power spectrum using the estimated pitch frequency;
a voiced/noise correction section that corrects the detected voiced band and noise band using the repaired pitch harmonic power spectrum;
a subtraction/attenuation coefficient calculation section that calculates a subtraction/attenuation coefficient for performing subtraction and attenuation on the voiced band and noise band corrected using the speech power spectrum and the noise base; and
a reconstruction section that multiplies the low band speech power spectrum by the subtraction/attenuation coefficient, and reconstructs a speech power spectrum in which a noise component is suppressed.

3. The band division noise suppression apparatus according to claim 1, wherein the high band noise suppression section comprises:
a suppression coefficient calculation section that calculates a suppression coefficient indicating a degree of noise suppression in a predetermined time unit;
a suppression coefficient adjustment section that adjusts a parameter of the calculated suppression coefficient; and
an averaging processing section that performs averaging processing of the adjusted suppression coefficient.

4. The band division noise suppression apparatus according to claim 3, further comprising a high band noise base estimation section that estimates a high band noise base comprising a noise component based on a power addition value of the high band speech signal in the predetermined time unit,
wherein the suppression coefficient calculation section calculates a suppression coefficient based on the power addition value of the high band speech signal and the high band noise base estimate value.

5. The band division noise suppression apparatus according to claim 3, comprising:
an SN ratio estimation section that estimates an SN ratio comprising a ratio between speech signal power and noise signal power in the predetermined time unit; and
a speech/noise frame determination section that determines a speech frame and a noise frame based on the high band speech signal and the high band noise base,
wherein the suppression coefficient adjustment section adjusts a parameter of a suppression coefficient based on the estimated SN ratio and the determined speech frame and noise frame.

6. The band division noise suppression apparatus according to claim 3, wherein the averaging processing section performs averaging processing on the obtained suppression coefficient, and performs noise suppression processing on a high band speech signal in a predetermined time unit using the averaging processing result.

7. A band division noise suppression method comprising:
a band division step of performing band division on an input speech signal into a low band speech signal including a low frequency noise component and a high band speech signal including a high frequency noise component;
a decimation processing step of performing down-sampling and decimation processing on the low band speech signal;
a low band noise suppression step of suppressing noise included in the low band speech signal subjected to the decimation processing;
an interpolation processing step of performing up-sampling and interpolation processing on the noise-suppressed low band speech signal;
a high band noise suppression step of suppressing noise included in the high band speech signal; and
a band combination step of combining the low band speech signal subjected to the interpolation processing and the high band speech signal subjected to the noise suppression processing.

8. The band division noise suppression method according to claim 7, wherein the low band noise suppression step comprises the steps of:
estimating a noise base comprising a noise component spectrum from a low band speech power spectrum;
detecting voiced band and noise band from the speech power spectrum using the speech power spectrum and the noise base;
extracting a pitch harmonic power spectrum from the speech power spectrum using the speech power spectrum and the noise base;
estimating a pitch frequency in the speech power spectrum using the speech power spectrum and the noise base;
repairing the extracted pitch harmonic power spectrum using the estimated pitch frequency;
correcting the detected voiced band and noise band using the repaired pitch harmonic power spectrum;
calculating a subtraction/attenuation coefficient for performing subtraction and attenuation on the voiced band and noise band corrected using the speech power spectrum and the noise base; and
reconstructing a speech power spectrum in which a noise component is suppressed by multiplying the low band speech power spectrum by the subtraction/attenuation coefficient.

9. The band division noise suppression method according to claim 7, wherein the high band noise suppression step comprises the steps of:
estimating high band noise base comprising a noise component based on a power addition value of the high band speech signal in a predetermined time unit;
estimating an SN ratio comprising a ratio between speech signal power and noise signal power;
determining a speech frame and a noise frame based on the high band speech signal and the high band noise base;
calculating a suppression coefficient indicating a degree of noise suppression based on the power addition value of the high band speech signal and the high band noise base estimate value;
adjusting a parameter of the calculated suppression coefficient based on the estimated SN ratio and the determined speech frame and noise frame; and
performing averaging processing of the adjusted suppression coefficient and performing suppression processing on the high band speech signal in a predetermined time unit using the average processing result.
